(19) United States
(12) Patent Application Publication
(10) Pub. No.: US 2007/0068464 A1
(43) Pub. Date: Mar. 29, 2007

(54) Treat ball

(76) Inventors: Susan Marie Smith, Quincy, MA (US); Andrew S. Katz, Andover, MA (US); Wylie Lai, Hong Kong (HK)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/490,354

(22) Filed: Jul. 20, 2006

Related U.S. Application Data
(60) Provisional application No. 60/700,803, filed on Jul. 20, 2005.

(51) Int. Cl. A01K 29/00

(52) U.S. Cl. 119/709

(57) ABSTRACT

A treat ball includes a transparent chamber for holding treats and end caps on the transparent chamber. At least one of the end caps includes one or more lobes, which causes the treat ball to roll in a non-uniform manner. Additionally, at least one of the end caps includes an opening into the chamber, and an adjustable mechanism configured to fully close the opening and to reveal the opening to varying degrees.

### RELATED APPLICATIONS

This application claims the benefit of and priority to U.S. Provisional Application No. 60/700,803, filed Jul. 20, 2005, which is hereby incorporated herein by reference.

### FIELD OF THE INVENTION

This invention relates to an improved treat ball for an animal or a pet such as a pet dog.

### BACKGROUND OF THE INVENTION

There are various known devices for dispensing animal food stored within them. Such food dispensers are often circular or cylindrical in shape and dispense food through openings in the device by rotating one or more parts. See, for example, U.S. Pat. Nos. 5,003,925; 5,213,232; and 5,232,130. One disadvantage of such devices is that they generally fail to provide proper exercise or amusement for an animal or pet. Moreover, even a food dispenser designed to give some amusement and exercise, such as the feeder disclosed in U.S. Pat. No. 3,999,519 for small animals, is not practical for larger pets such as dogs.

Additionally, there are various pet toys for amusement only but which do not contain animal food as an enticement and reward. A conventional cat toy includes a spherical hollow external ball having holes and containing a smaller opaque ball. The holes allow the cat to insert its paw and play with the internal ball. See U.S. Pat. No. 5,351,650. A pet toy that is a variation on this concept is disclosed in U.S. Pat. No. 5,009,193. The external compartment is a toroidal enclosure which includes an opening that is large enough for the ball inside to be removed by the cat. While toys of this type may entertain the pet for a time, such toys do not entice or reward the pet with a treat.

Animal toys for the amusement and diversion of the pet which emanate various sounds when squeezed, shaken or rolled are also known, but these toys often fail to properly entice or reward the pet with a treat.

Other pet toys are known to combine amusement with dispensing food, such as treat-discharging toys or balls. Typical treat-discharging animal or pet toys are filled with treats such as artificial bones or other edible objects. The treat toy discharges the treats in response to pushing or shaking by an animal, usually a pet such as a dog. Such treat toys include holes large enough for the treat to pass through when pulled out by the pet or animal. See U.S. Pat. No. 5,343,828. Alternatively, treats fall through the holes randomly as the treat ball, which is typically spherical, rolls when played with by the pet. See U.S. Pat. No. 5,819,690.

However, these conventional pet treat balls also have several disadvantages. One disadvantage is that the treat balls are typically spherical in shape, and thus roll in a regular manner when played with, which may translate to eventual boredom for the animal. Another disadvantage is that the rate of dispensation of the treats is limited by the fixed size and shape of the holes in the ball.

U.S. Pat. No. 2,086,631 discloses a spherical cat toy adapted to dispense catnip including circular and elongated duct means and closure means constructed to close, partially open and completely open the duct means. However, the cat toy disclosed in the '631 patent is spherical, which could lead to boredom and disinterest. Also, the '631 patent discloses that the treat ball is necessarily weighted in some embodiments in order to prevent the toy from rolling great distances. Also, the opening and closing of the duct means is effected by adjusting portions of the spherical ball itself, and does not provide for a separate adjustment mechanism. Moreover, the treat within is not visible to the cat when the ducts are closed.

### SUMMARY OF THE INVENTION

It is therefore an object of this invention to provide an improved treat ball for an animal or a pet such as a pet dog.

It is a further object of this invention to provide a treat ball that tumbles non-uniformly when moved and, even then, only for short distances.

It is a further object of this invention to provide a treat ball that visibly reveals the treats within and emits sounds when moved or shaken.

It is a further object of this invention to provide a treat ball that includes an adjustable mechanism thereon to accommodate and dispense treats of various sizes and to control dispensation of treats.

It is a further object of this invention to provide a treat ball that increases the challenge, excitement and stimulation for an animal or pet.

It is a further object of this invention to provide a treat ball that enhances enticement for the animal or pet.

The invention results from the realization that an improved treat ball for providing enticement and stimulation for an animal or a pet can be achieved by configuring the treat ball such that it will not roll uniformly or for great distances but rather will tumble irregularly and not far from the pet. The invention also results from the further realization that such an improved treat ball can be achieved by visibly revealing the treats within the treat ball to the pet, and by including an adjustable mechanism thereon for accommodating treats and for controlling the dispensing of treats from the treat ball.

The subject invention, however, in other embodiments, need not achieve all these objectives and the claims hereof should not be limited to structures or methods capable of achieving these objectives.

This invention features a treat ball including a transparent chamber for holding treats therein, and end caps on the chamber at least one of which includes one or more lobes causing the treat ball to roll in a non-uniform manner. At least one said end cap includes an opening into said chamber and an adjustable mechanism configured to fully close said opening and to reveal said opening to varying degrees. The transparent chamber may be cylindrical in shape and may include a central post. Both end caps may each include two sets of opposing, equally spaced lobes. At least one end cap may include a first plate covering an open end of said chamber, said first plate including the opening. The adjustable mechanism may include a second plate rotatably disposed on said first plate, and said second plate may include a window alignable with said opening in said first plate. The second plate may include at least one catch member thereon and said first plate may include a plurality of detents cooperating with said catch member to releasably lock said window in position relative to said opening. The treat ball may include a sound effect mechanism, and the sound effect mechanism may be located in a said end cap.

This invention also features a treat ball including a transparent chamber for holding treats therein, and end caps on the chamber each including two opposing, equally spaced lobes causing the treat ball to roll in a non-uniform manner. At least one said end cap may include an opening into said chamber and may include an adjustable mechanism configured to fully close said opening and to reveal said opening to varying degrees.

This invention further features a treat ball including a transparent chamber for holding treats therein, end caps on said chamber at least one of which includes one or more lobes causing the treat ball to roll in a non-uniform manner, a first plate covering an open end of said chamber, said first plate including an opening into said chamber, and a second plate rotatably disposed on said first plate, and said second plate may include a window alignable with said opening in said first plate.

This invention also features a treat ball including a transparent chamber for holding treats therein, end caps on said chamber at least one of which includes one or more lobes causing the treat ball to roll in a non-uniform manner. At least one said end cap may include an opening into said chamber and may include an adjustable mechanism configured to fully close said opening and to reveal said opening to varying degrees. A sound effect mechanism may be located in a said end cap.

This invention further features a treat ball including a transparent chamber for holding treats therein, and end caps on the chamber at least one of which includes two opposing equally spaced lobes causing the treat ball to roll in a non-uniform manner, a first plate covering an open end of said chamber, said first plate including an opening, a second plate rotatably disposed on said first plate, said second plate may include a window alignable with said opening in said first plate, and a sound effect mechanism may be located in a said end cap.

### BRIEF DESCRIPTION OF THE DRAWINGS

Other objects, features and advantages will occur to those skilled in the art from the following description of a preferred embodiment and the accompanying drawings, in which:

FIG. 1 is a schematic side view of one example of a treat ball in accordance with the present invention shown without treats inside;

FIGS. 2-5 are schematic top views of the treat ball of FIG. 1 showing more detailed views of the adjustable mechanism in various configurations;

FIG. 6 is a schematic exploded view of the treat ball and adjustable mechanism in accordance with the invention;

FIG. 7 is a schematic cross-sectional enlarged view of one embodiment of the adjustable mechanism shown in FIGS. 2-5;

FIG. 8 is a schematic side view of the treat ball of FIG. 1 shown with treats inside; and

FIG. 9 is a close up schematic view of the treat ball of FIG. 1 showing a treat partially dispensed from the treat ball.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

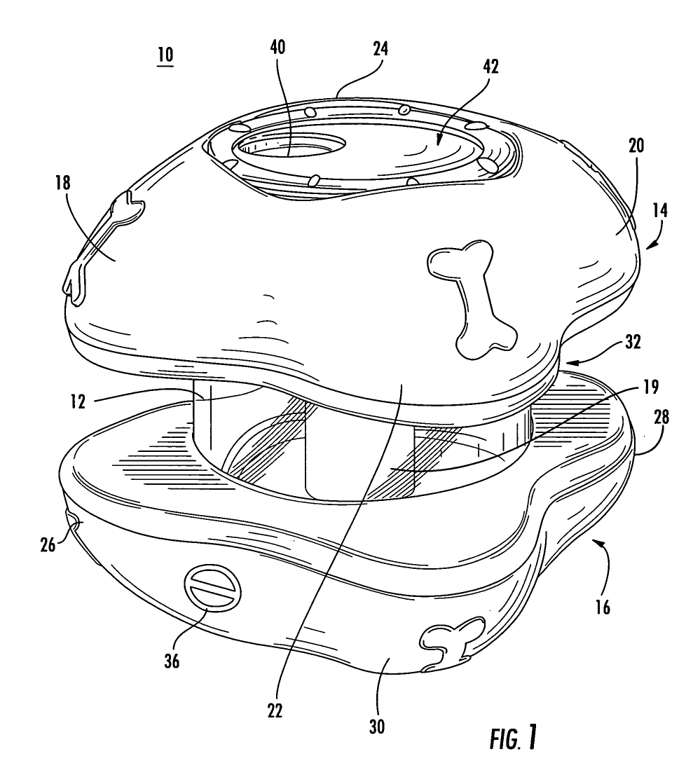

Treat ball 10 in accordance with the present invention is shown in FIG. 1. Treat ball 10 includes transparent chamber 12 for holding treats therein. Through transparent chamber 12, an animal or pet can see the treats within, thus creating greater interest than conventional pet toys where treats are not visible or where there are no treats at all.

Treat ball 10 includes end caps 14 and 16 disposed on transparent chamber 12. Either end cap 14 or 16, or both, includes one or more lobes such as lobes 18-32. In this example, end cap 14 includes lobes 18, 20, 22 and 24, and end cap 16 includes lobes 26, 28, 30 and 32. When treat ball 10 rolls, as when played with by a pet, lobes 18-32 cause treat ball 10 to roll in a non-uniform manner. Also, the non-spherical shape of treat ball 10, including lobes 18-32, prevent treat ball 10 from rolling very far before stopping. Thus, treat ball 10 helps prevent the pet from becoming disinterested in treat ball 10 because it does not simply rolls along or rolls completely away from the pet, in contrast to conventional treat balls.

Either end cap 14 or end cap 16, or both, may include an opening into transparent chamber 12. As shown in FIG. 1, end cap 14 includes opening 40 into transparent chamber 12. Adjustable mechanism 42 is configured to fully close opening 40 and to reveal opening 40 to varying degrees, as discussed in more detail below. Typically, end cap 14 may include two opposing equally spaced lobe sets 18, 20 and 22, 24 and end cap 16 may include two opposing equally spaced lobe sets 26, 28 and 30, 32. Transparent chamber 12 is typically cylindrical in shape and may include a central post 19 within which is connected to end caps 14 and 16.

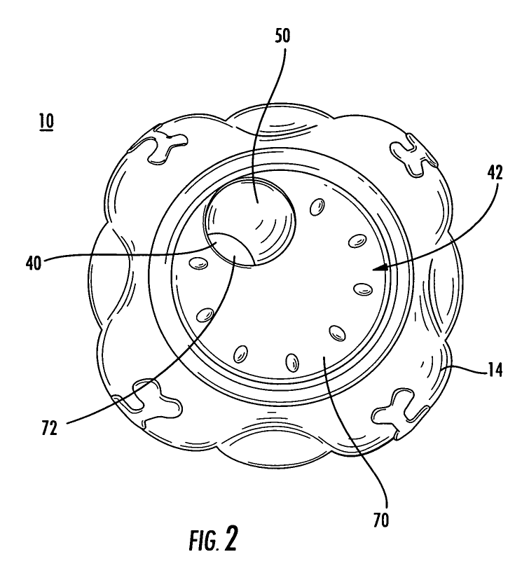

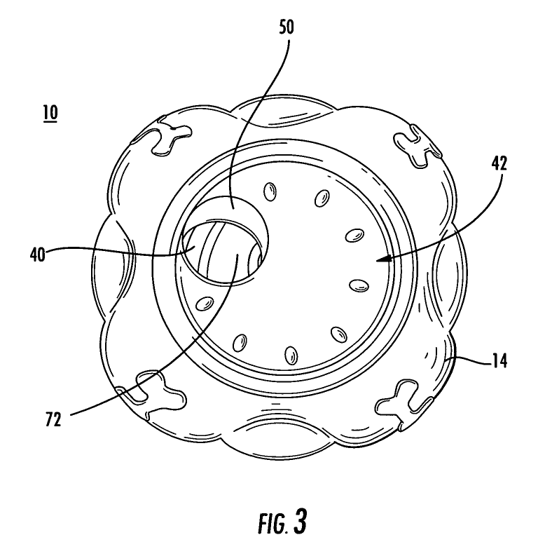

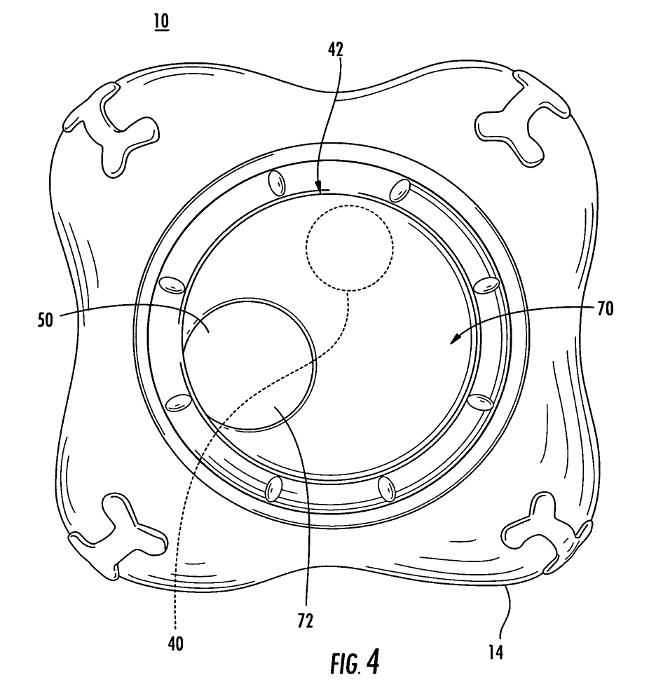

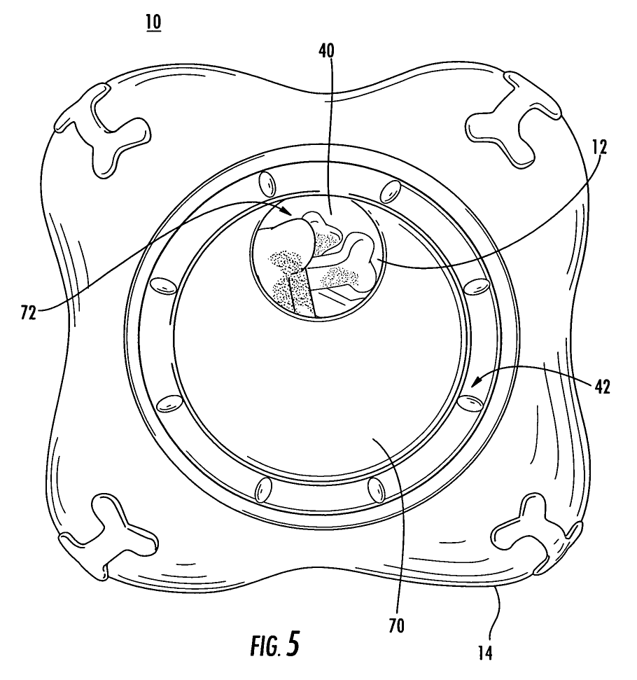

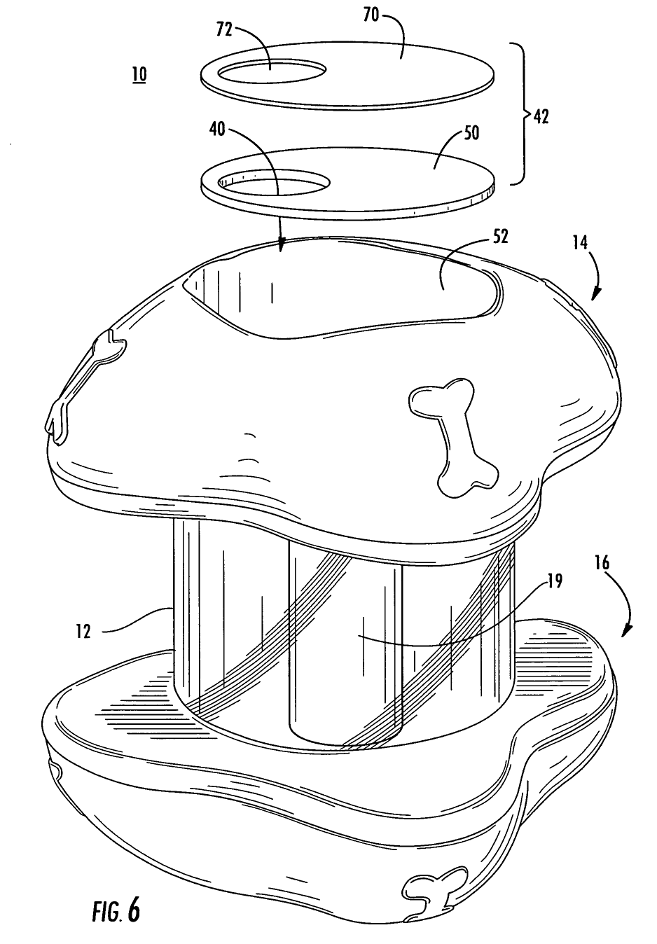

Adjustable mechanism 42, FIG. 2, of treat ball 10 includes first plate 50. First plate 50 includes opening 40 into transparent chamber 12. Adjustable mechanism 42 further includes a second plate 70 rotatably disposed on first plate 50, and second plate 70 includes window 72 alignable with opening 40 in first plate 50 to reveal opening 40 to varying degrees. In FIG. 2, opening 40 is revealed to a small degree. In FIG. 3, opening 40 is revealed to a slightly larger degree. In FIG. 4, opening 40 (not visible) is fully closed. In this fully closed configuration, window 72 in second plate 70 is not aligned with opening 40 (shown in phantom) of first plate 50. In FIG. 5, adjustable mechanism 42 fully reveals opening 40, through which the inside of transparent chamber 12 can be seen. In FIG. 5, window 72 is completely aligned with opening 40 included in first plate 50. FIG. 6 is an exploded view of treat ball 10 showing adjustable mechanism 42 including plates 50 and 70, window 72 in plate 70, opening 40 into chamber 12 included in plate 50, as well as the open end 52 of chamber 12 covered by plate 50.

Thus, with adjustable mechanism 42, treat ball 10 can accommodate various sizes and types of treats. Alternatively, the size of opening 40 may be set too small to accommodate a treat, but large enough for the pet to smell the scent of the treat. In the latter case, the pet can see the treats as well as smell them, enhancing the anticipation of a reward for the pet.

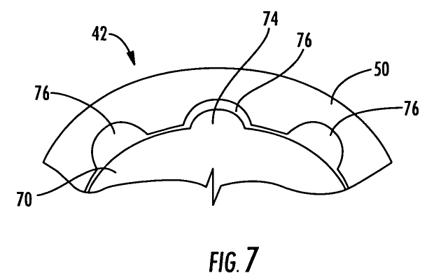

In one example, second plate 70, FIG. 7, typically includes at least one catch member 74 thereon. First plate 50 includes a plurality of detents 76 cooperating with catch member 74 to releasably lock window 72 in position relative to opening 40. The detents are spaced at predetermined intervals to fix the size of opening 40 into chamber 12, as shown in FIGS. 3, 4 and 5. In this way, treat ball 10 can accommodate and dispense treats of various sizes. Also, chamber 12 can be filled with large and small treats at the same time, and the size of opening 40 can be adjusted to only allow the smaller treats to be dispensed.

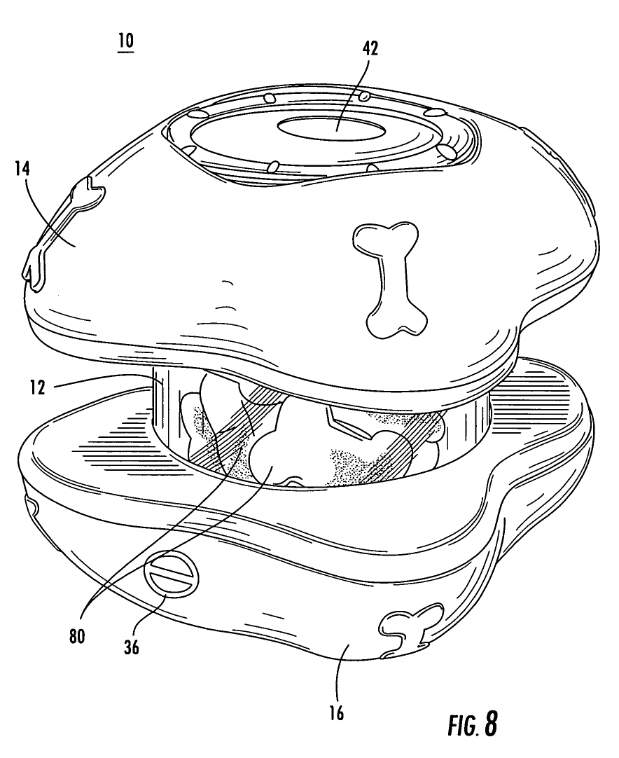

FIG. 8 shows treat ball 10 filled with treats 80, which are visible to a pet through transparent chamber 12, even though adjustable mechanism 42 fully closes opening 40 (not shown) into chamber 12. Preferably, treat ball 10 further includes sound effect mechanism 36 which may be located on either end cap 14 or 16. Various sound effect mechanisms are known in the art, and the subject invention may include any such mechanisms. In one example, sound effect mechanism 36 is configured to make a giggling sound as known in the art. Sound effect mechanism 36, in combination with the other features of treat ball 10 of the subject invention, tends to add to the pet's amusement.

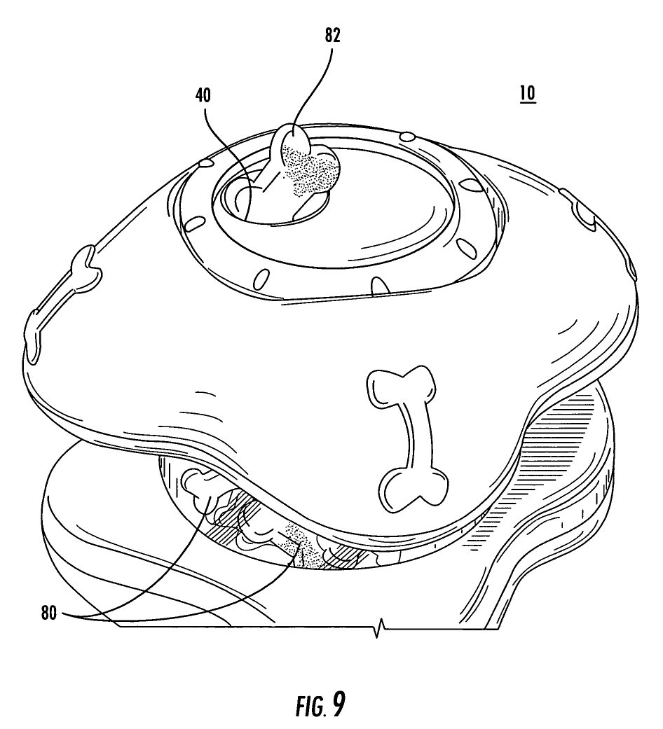

In FIG. 9, exemplary treat 82 is shown partially within opening 40 into chamber 12. Thus, it is clear that chamber 12 may be filled with treats 80, 82 through opening 40, or that the pet may be rewarded by treats 80, 82 dispensed through opening 40. In one example, chamber 12 and end caps 14 and 16 are made of plastic. However, any other suitable material may be used, with the consideration that it should be sufficiently strong to avoid easy breakage by the pet, although this is not necessarily a limitation of the invention.

The present invention's transparent chamber, end caps including lobes, and the adjustment mechanism, maximize the pet's interest, reward the pet, as well as control the dispensation of the reward. The pet can visualize the treats, smell them, and/or knock the treats loose from the treat ball. The pet will not have to chase the treat ball too far, and the irregular motion and sound emitted will also improve the pet's playtime activity.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A treat ball comprising:
a transparent chamber for holding treats therein; and
end caps on said chamber at least one of which includes one or more lobes causing the treat ball to roll in a non-uniform manner,
at least one said end cap including an opening into said chamber and an adjustable mechanism configured to fully close said opening and to reveal said opening to varying degrees.

2. The treat ball of claim 1 in which said transparent chamber is cylindrical in shape.

3. The treat ball of claim 2 further including a central post in said cylindrical chamber.

4. The treat ball of claim 1 in which both end caps each include two sets of opposing, equally spaced lobes.

5. The treat ball of claim 1 in which said at least one end cap includes a first plate covering an open end of said chamber, said first plate including the opening.

6. The treat ball of claim 5 in which said adjustable mechanism includes a second plate rotatably disposed on said first plate, said second plate including a window alignable with said opening in said first plate.

7. The treat ball of claim 6 in which said second plate includes at least one catch member thereon and said first plate includes a plurality of detents cooperating with said catch member to releasably lock said window in position relative to said opening.

8. The treat ball of claim 1 further including a sound effect mechanism.

9. The treat ball of claim 8 in which said sound effect mechanism is located in a said end cap.

10. A treat ball comprising:
a transparent chamber for holding treats therein; and
end caps on said chamber each including two opposing, equally spaced lobes causing the treat ball to roll in a non-uniform manner;
at least one said end cap including an opening into said chamber and an adjustable mechanism configured to fully close said opening and to reveal said opening to varying degrees.

11. A treat ball comprising:
a transparent chamber for holding treats therein;
end caps on said chamber at least one of which includes one or more lobes causing the treat ball to roll in a non-uniform manner;
a first plate covering an open end of said chamber, said first plate including an opening into said chamber; and
a second plate rotatably disposed on said first plate, said second plate including a window alignable with said opening in said first plate.

12. A treat ball comprising:
a transparent chamber for holding treats therein;
end caps on said chamber at least one of which includes one or more lobes causing the treat ball to roll in a non-uniform manner, at least one said end cap including an opening into said chamber and an adjustable mechanism configured to fully close said opening and to reveal said opening to varying degrees; and
a sound effect mechanism located in a said end cap.

13. A treat ball comprising:
a transparent chamber for holding treats therein;
end caps on said chamber at least one of which includes two opposing equally spaced lobes causing the treat ball to roll in a non-uniform manner;
a first plate covering an open end of said chamber, said first plate including an opening;
a second plate rotatably disposed on said first plate, said second plate including a window alignable with said opening in said first plate; and
a sound effect mechanism located in a said end cap.
